(19) United States
(12) Patent Application Publication
(10) Pub. No.: US 2009/0044414 A1
(43) Pub. Date: Feb. 19, 2009

(54) Drywall ripper

(76) Inventor: Travis Connelly, Fredericksburg, VA (US)

Correspondence Address: Raymond M. Galasso;Galasso & Associates LP, P.O. Box 26503, Austin, TX, 78755-0503, US

(21) Appl. No.: 11/893,471

(22) Filed: Aug. 16, 2007

(51) Int. Cl. B26B 29/06

(52) U.S. Cl. 30/294

(57) ABSTRACT

Drywall Ripper is a sliding housing with a cutting mechanism for use with a T-square or the like. The preferred embodiment of the invention utilizes a housing, a slot in the housing with a magnet to hold a blade, clamping components within the housing activated with a clamping button on the housing, a release button on the housing to disengage the clamping components, a viewer opening on the housing, and a groove in the housing for insertion onto a T-square. To use the preferred embodiment of Drywall Ripper, an individual uses the groove to place the housing onto a T-square. The clamping button is then pressed to lock the clamping components of the device at the desired measurement on the T-square. The top of the T-square is then placed on a flat surface parallel to the ground and a piece of drywall is placed perpendicular to the flat surface, supported against its backside. The entire T-square with housing attached is then dragged across the drywall with the top of the T-square still on the flat surface, making a precise cut with the blade at the desired location on the drywall. When the user is finished making the cut, the release button is pressed, allowing the user to move the housing on the T-square to a different measurement if desired.

### CROSS REFERENCE TO RELATED APPLICATIONS

This U.S. Non-Provisional Patent Application does not claim priority to any U.S. Provisional patent application or any foreign patent application.

### FIELD OF THE DISCLOSURE

The disclosures made herein relate generally to the drywalling tools and accessories industry. The invention discussed herein is in the general classification of devices for cutting drywall.

### BACKGROUND

Gypsum is one of the most widely used minerals in the world with millions of pounds of gypsum consumed annually. A large percentage of the gypsum in the United States is used for making wallboard for homes, offices, and commercial buildings. Wallboard or plasterboard is a thin coat of plaster between two sheets of cardboard. The plaster is made from natural gypsum mined from quarries or from synthetic gypsum produced from scrubbing smokestacks in electrical power plants or from other industrial waste streams.

Many tools are used in conjunction with drywalling and spackling. Some of these include: taping heads, pumps, roller handles, glazing head handles, and bridger handles. Knives or other instruments or devices must also be used to cut drywall sections to appropriate sizes for installation.

Traditional knives are dangerous to work with and are not precise enough instruments for cutting drywall to exact dimensions. Other cutting devices in use are safer and more precise but none permit simultaneous cutting and measuring.

Hence, there is a need in the art for a convenient to use, inexpensive, durable, safe and effective device for cutting and measuring drywall.

### SUMMARY OF THE DISCLOSURE

Drywall Ripper is a sliding housing with a cutting mechanism for use with a T-square or the like.

The preferred embodiment of the invention utilizes a housing, a slot in the housing with a magnet to hold a blade, clamping components within the housing activated with a clamping button on the housing, a release button on the housing to disengage the clamping components, a viewer opening on the housing, and a groove in the housing for insertion onto a T-square.

Other embodiments of the invention utilize slots through both ends of the housing to hold a T-square rather than the groove of the preferred embodiment. In this embodiment, the blade runs perpendicular to the slots to allow the housing to be moved along the T-square for cutting.

The principal object of this invention is to provide a device to simultaneously measure and cut drywall.

Another object of this invention is to provide a device to efficiently cut drywall.

Another object of this invention is to provide an inexpensive device to cut drywall.

Another object of this invention is to provide a safe device to cut drywall.

Another object of this invention is to provide a device to accurately measure and cut drywall.

Yet another object of this invention is to provide a durable device to cut drywall.

### BRIEF DESCRIPTION OF THE DRAWINGS

FIG. 1 depicts an overhead view of the preferred embodiment of the present invention.

FIG. 2 depicts a perspective view of an alternative embodiment of the present invention.

FIG. 3 depicts a bottom view of the alternative embodiment of the present invention discussed in conjunction with FIG. 2 attached to a T-square.

### DETAILED DESCRIPTION OF THE DRAWINGS

The preferred embodiment of the invention is comprised of at least some of the following: a housing, a slot in the housing with a magnet to hold a blade, clamping components within the housing activated with a clamping button on the housing, a release button on the housing to disengage the clamping components, a viewer opening on the housing, and a groove in the housing for insertion onto a T-square.

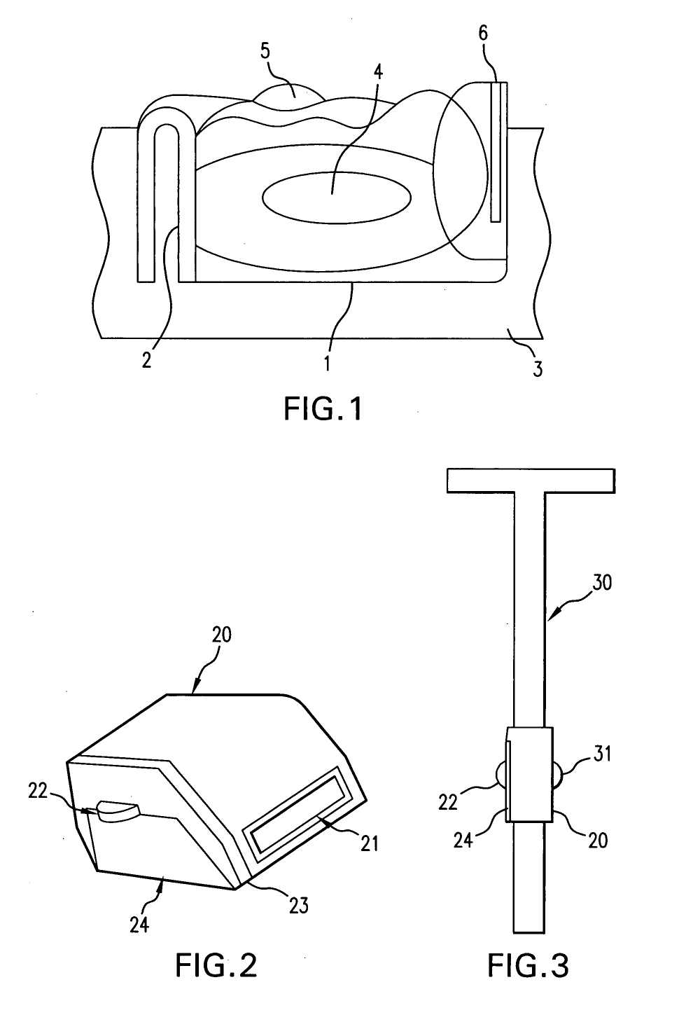

FIG. 1 depicts an overhead view of the preferred embodiment of the present invention. A housing 1 has a viewer opening 2 at one side. The housing 1 is made of either plastic or metal in the preferred embodiment though other materials can also be used. The housing 1 is approximately rectangular in the preferred embodiment though other shapes will also work. The housing 1 is between one and one and a half inches in height, three inches in length, and two inches in width in the preferred embodiment though other dimensions can also be utilized.

The housing 1 has a groove (not pictured) along its length to permit it to be inserted onto a T-square 3. The groove extends approximately an inch and a half from the front of the housing 1 into the width of the housing 1 and is dimensioned to fit virtually any thickness T-square. The viewer opening 2 permits a user to see the measurement marking on the T-square 3 when the T-square 3 is inserted into the groove of the housing 1. The viewer opening 2 has a horseshoe shape in this preferred embodiment though the exact shape is not critical to the invention.

A clamping button 4 that is oval in shape is located on top and in the center of the housing 1 though the shape and location of the clamping button 4 are not critical. The clamping button 4 is operatively connected to clamping components (not pictured) within the housing 1. These clamping components engage the T-square 3 when the T-square 3 is inserted into the groove of the housing 1 and the clamping button 4 is pressed. A release button 5 is located on the rear of the housing 1 and is operatively connected to the clamping components to disengage them from the T-square 3 when desired. The release button 5 slightly protrudes from the rear of the housing 1 for ease of use in this preferred embodiment.

A slot 6 is located on the side of the housing opposite the viewer opening 2. A magnet (not pictured) is located within the slot 6 of the housing 1. The slot 6 and magnet are designed to hold a metal blade within the housing 1. The blade will protrude from the rear of the housing 1 perpendicular to the T-square 3.

FIG. 2 depicts a perspective view of an alternative embodiment of the present invention. The housing 20 is made of either plastic or metal in this alternative embodiment. The housing 20 is approximately rectangular in this alternative embodiment. The housing 20 is between one and one and a half inches in height, three inches in length, and two inches in width in this alternative embodiment as well. The exact materials, shape and dimensions of the housing, however, are not critical to the alternative embodiment.

A first slot 21 is located on one side of the housing and a second slot (not pictured) is located on the other side of the housing. The first slot 21 and the second slot are dimensioned to fit virtually any size T-square and allow a T-square to extend through the length of the housing 20.

A clamping button 22 is located on the rear of the housing 20. The clamping button 22 is operatively connected to clamping components (not pictured) within the housing 20. These clamping components engage a T-square when a T-square is inserted through the first slot 21 and second slot of the housing 20 and the clamping button 22 is pressed. A release button (not pictured) is located on the front of the housing 20 to disengage the clamping components.

A magnet 23 is located on the rear of the housing 20. The magnet 23 is designed to hold a blade 24 made of metal along the rear of the housing 20 beneath the clamping button 22. The blade 24 will protrude slightly from the bottom of the housing 20 parallel to the bottom of an attached T-square and perpendicular to the first slot 21 of the housing 20.

FIG. 3 depicts a bottom view of the alternative embodiment of the present invention discussed in conjunction with FIG. 2 attached to a T-square. The T-square 30 is shown protruding through the first slot and second slot of the housing 20. The blade 24, the clamping button 22 and the release button 31 all are visible in this figure.

To use the preferred embodiment of Drywall Ripper, an individual uses the groove to place the housing onto a T-square. The clamping button is then pressed to lock the clamping components of the device at the desired measurement on the T-square. The top of the T-square is then placed on a flat surface parallel to the ground and a piece of drywall is placed perpendicular to the flat surface, supported against its backside. The entire T-square with housing attached is then dragged across the drywall with the top of the T-square still on the flat surface, making a precise cut with the blade at the desired location on the drywall. When the user is finished making the cut, the release button is pressed, allowing the user to move the housing on the T-square to a different measurement if desired.

With the alternative embodiment, a user would use the slots to place the housing on the T-square. The T-square with the housing attached is then placed onto a piece of drywall on the ground or workbench, and the housing is dragged along the T-square to make a precise and straight cut on the drywall. The clamping button can be used to store the housing on the T-square and the release button can be used to allow the housing to be freely moved along the T-square when desired.

The materials utilized for Drywall Ripper may vary widely but will likely include metals and plastic. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Drywall Ripper can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

It should be obvious that the components of the present invention can be of various shapes and sizes. It should also be obvious that the components of the invention can be made of different types of metals, plastics or other suitable materials and can be of any color.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A drywall cutting device comprising:
(a) a housing containing a clamping component;
(b) a groove along the length of the housing;
(c) a clamping button located on the housing operatively connected to the clamping component; and
(d) an attachment mechanism for a blade on the housing.

2. The device of claim 1 wherein the housing is made of plastic.

3. The device of claim 1 wherein the housing is made of metal.

4. The device of claim 1 wherein the housing is approximately rectangular.

5. The device of claim 1 further comprising
a release button located on the housing operatively connected to the clamping component.

6. The device of claim 1 further comprising
a viewer opening on the housing.

7. The device of claim 1 wherein the attachment mechanism is a slot dimensioned to receive a blade.

8. The device of claim 7 further comprising
a magnet located in the slot.

9. The device of claim 1 further comprising
a T-square insertable into the groove of the housing.

10. A drywall cutting device comprising:
(a) a housing containing a clamping component;
(b) a first slot and a second slot on opposite sides of the housing;
(c) a clamping button located on the housing and operatively connected to the clamping component;
(d) a release button located on the housing and operatively connected to the clamping component; and
(e) a blade connected to the housing perpendicular to the first slot and the second slot.

11. The device of claim 10 further comprising
a magnet on the housing perpendicular to the first slot and the second slot for holding the blade.

12. The device of claim 10 further comprising
a T-square protruding through the first slot and the second slot of the housing.

13. A drywall cutting device comprising:
(a) a housing containing a clamping component;
(b) a groove along the length of the housing;
(c) a clamping button located on the housing and operatively connected to the clamping component;
(d) a release button located on the housing and operatively connected to the clamping component;
(e) a slot lined with a magnet on one side of the housing dimensioned to receive a blade; and
(f) a viewer opening on the side of the housing opposite the slot.

13. The device of claim 12 further comprising
a T-square insertable in the groove.
